(19) United States
(12) Patent Application Publication
(10) Pub. No.: US 2016/0048864 A1
(43) Pub. Date: Feb. 18, 2016

(54) THIRD PARTY DIGITAL WALLET PAY WITH POINTS

(71) Applicant: American Express Travel Related Services Company, Inc., New York, NY (US)

(72) Inventors: Allison P. Beer, New York, NY (US); Cecile M. Berta, New York, NY (US); Lan Anh Hoang, New York, NY (US); Trey Neemann, Glendale, AZ (US)

(73) Assignee: American Express Travel Related Services Company, Inc., New York, NY (US)

(21) Appl. No.: 14/459,029

(22) Filed: Aug. 13, 2014

(51) Int. Cl. G06Q 30/02; G06Q 20/24; G06Q 20/02; G06Q 20/36

(52) U.S. Cl. CPC G06Q 30/0226; G06Q 20/36; G06Q 20/24; G06Q 20/02

(57) ABSTRACT

A system, method and computer program product for redemptions of reward points to purchase goods and services offered by a third-party digital wallet or merchant aggregator. A single integration with a merchant aggregator enables cross-merchant functionality. This system, method and computer program may allow certain transaction account holders to directly pay with their loyalty points (“points”) in any third party digital wallet. Utilizing the system, transaction account holders may earn one or more point for virtually every dollar charged on eligible, enrolled transaction account and then redeem their points for a wide array of rewards, including retail merchandise or travel.

### FIELD

The present disclosure generally relates to financial transactions, and more particularly, a system and method of processing financial transactions using reward points.

### BACKGROUND

Traditional loyalty (e.g., incentive award, frequency reward, etc.) programs have existed for years. Loyalty programs are typically used to help businesses develop and maintain participant loyalty and are typically used as marketing tools to develop new clientele. A frequent flyer program is an example of a typical loyalty program, where the more the participant uses a particular airline or group of affiliated airlines, the more frequent flyer miles the participant earns. After accumulating frequent flyer miles, the participant may choose to redeem those miles for upgrades in service or free airline tickets.

Various forms of these programs have developed over the years, ranging from programs such as “buy 9 get one 1” punch cards to more sophisticated credit card loyalty systems, where participants are awarded points for using a particular transaction card. As competition in various markets increased, companies sought ways to expand loyalty programs to appeal to a broader cross-section of potential customers. One way this was accomplished was by developing strategic partnerships and affiliations with other business sectors. For example, hotel chains, airlines and rental car agencies developed loyalty program partnerships and affiliations; credit and transaction card companies also joined in to promote a more comprehensive and appealing loyalty program. These programs have been successful, but again were limited in that the loyalty points could only be redeemed within the network of companies in the loyalty program affiliation or partnership.

Although many of these programs have been successful in developing customer loyalty and incentivizing customers to act, they have presented participants with limited opportunities to redeem loyalty points for the products of their choice or have provided participants with limited accessibility and control of their loyalty account. Therefore, a need exists in this industry for a program that expands product choice for loyalty program participants.

### SUMMARY

The present disclosure meets the various needs described above by providing a system, method and computer program product for utilizing loyalty and/or rewards points. According to various embodiments, the system comprises receiving an inquiry from a merchant aggregator system to a membership rewards program host system to verify that rewards points can be used for a payment of a transaction. The system may comprise verifying, in response to the transaction being eligible for a membership rewards program, an amount of rewards points that can be used to complete the transaction. The system may comprise receiving a selection to pay with points from the membership rewards program. The merchant aggregator system may transmit a service call to the membership rewards program host system to indicate a transaction account holder intends to pay with points for the transaction. The system may comprise recording the pay with points (PWP) intent. The transaction may be processed utilizing a transaction account by a payment processor to form a processed transaction.

In various embodiments, the system may comprise linking a record of the processed transaction with the recorded pay with points intent, in response to a merchant submitting a settlement request for the transaction. The system may comprise requesting that a credit be applied to the transaction account in an amount of the transaction and that an associated amount of rewards points be reduced in a transaction account holder's rewards points account (in a membership rewards program), in response to forming the link. The system may comprise issuing a statement credit to the transaction account used for the payment of the transaction and reducing the associated amount of rewards points in the transaction account holder's rewards points account based on the request passing conditions.

### BRIEF DESCRIPTION OF THE DRAWINGS

The features and advantages of the present disclosure will become more apparent from the detailed description set forth below when taken in conjunction with the drawings. The left-most digit of a reference number identifies the drawing in which the reference number first appears.

FIG. 1 depicts a block diagram of a process flow of a transaction according to various embodiments of the disclosure; and

FIG. 2 illustrates a block diagram depicting portions of a process flow of a loyalty point system according to various embodiments of the disclosure.

### DETAILED DESCRIPTION

The detailed description of exemplary embodiments herein makes reference to the accompanying drawings and pictures, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

The phrases consumer, customer, user, transaction account holder, card member or the like shall include any person, entity, business, government organization, business, software, hardware, machine associated with a transaction account, buys merchant offerings offered by one or more merchants using the account and/or who is legally designated for performing transactions on the account, regardless of whether a physical card is associated with the account. For example, the card member may include a transaction account owner, a transaction account user, an account affiliate, a child account user, a subsidiary account user, a beneficiary of an account, a custodian of an account, and/or any other person or entity affiliated or associated with a transaction account.

The present disclosure meets the various needs described above by providing a system, method and computer program product for redemptions of reward points to purchase goods and services offered by a third-party digital wallet or merchant aggregator. Conventionally, payment with reward points capabilities are specific to a merchant. In contrast to this sole provider format, a cross-merchant integration with a third-party wallet or merchant aggregator is contemplated herein. In this way, a single integration with a merchant aggregator enables cross-merchant functionality. Merchants may benefit due to ease of integration. Merchant aggregator's may be able to offer an expanded array of services. Transaction account holders benefit by being availed of additional points redemption options. Moreover, the transaction account holders' experience may be simplified. For instance, the transaction account holders do not need to enter their name, their billing address, their shipping address, their credit card information at checkout, as this information may be stored by each digital wallet. In this way, an expedited and secure way to check out using points is available versus having to go through the full checkout experience (described in further detail below).

According to various embodiments, a system and/or software (e.g., plug-in) may be described that will allow certain transaction account holders to directly pay with their loyalty points (“points”) in any third party digital wallet. Utilizing the system, transaction account holders may earn one or more point for every dollar charged (or any portion) on an eligible, enrolled transaction account (such as an American Express transaction account) and then redeem their points for a wide array of rewards, including retail merchandise or travel. Currently, points may be redeemed on transaction account issuer specific dedicated websites (membershiprewards.com or shopamex.com), via the “Use Points for Charges” feature in a mobile and/or tablet app, or at select third party retailers or service providers. The technology 0described herein enables transaction account holders to use points very broadly in other third-party digital wallets for which loyalty point and/or a membership rewards program host system is integrated. In the present system, the merchant or its service provider is the party identifying (registering) the intent to use points rather than a membership rewards program host system and/or transaction account issuer proprietary application and/or app. Also, in contrast to conventional pay with points systems, the transaction account holder is not requesting a points redemption from the membership rewards program host system. This solution is highly replicable, as a single integration with the third-party digital wallet and/or aggregator enables leverage of the system 100 for all the merchants within the aggregator's network.

According to various embodiments, the third party digital wallet pay with points system 100 (“system 100”) changes the traditional paradigm of integrating a single rewards program with individual merchants, by integrating a single pay with points system with multiple digital wallet providers.

As used herein, a “digital wallet” includes a software and/or electronic device that facilitates individual e-commerce and m-commerce transactions either by aggregating the transaction account holder's payment and billing information and serving as the merchant of record, or passing through the transaction account holder's payment and billing information to the end merchant.

As used herein, “express check-out” may be defined as a type of digital wallet that resides on a merchant's e-commerce or m-commerce site. The express check-out may provide and expedite payment by aggregating or passing through the transaction account holder's billing information.

Increasingly, digital wallets are being created not just for basic financial transactions, but to also authenticate the holder's credentials. For example, a digital-wallet could potentially verify the age of the buyer to the store while purchasing alcohol. Digital wallets may encompass an electronic infrastructure, the software that operates in conjunction with the electronic infrastructure and the device. Traditionally, a digital wallet includes both a software and an information component. The software provides security and encryption for personal information and/or transaction details. Typically, digital wallets are stored on the client side and are easily self-maintained and fully compatible with an e-commerce Web site. Server-side digital wallets are gaining popularity among major retailers due to the security, efficiency, and added utility they provide to the end-user, which increases their satisfaction of their overall purchase. The information component is basically a database of user-inputted information. This information may include a shipping address, billing address, payment methods (including credit card codes, expiry dates, and security numbers), and other information.

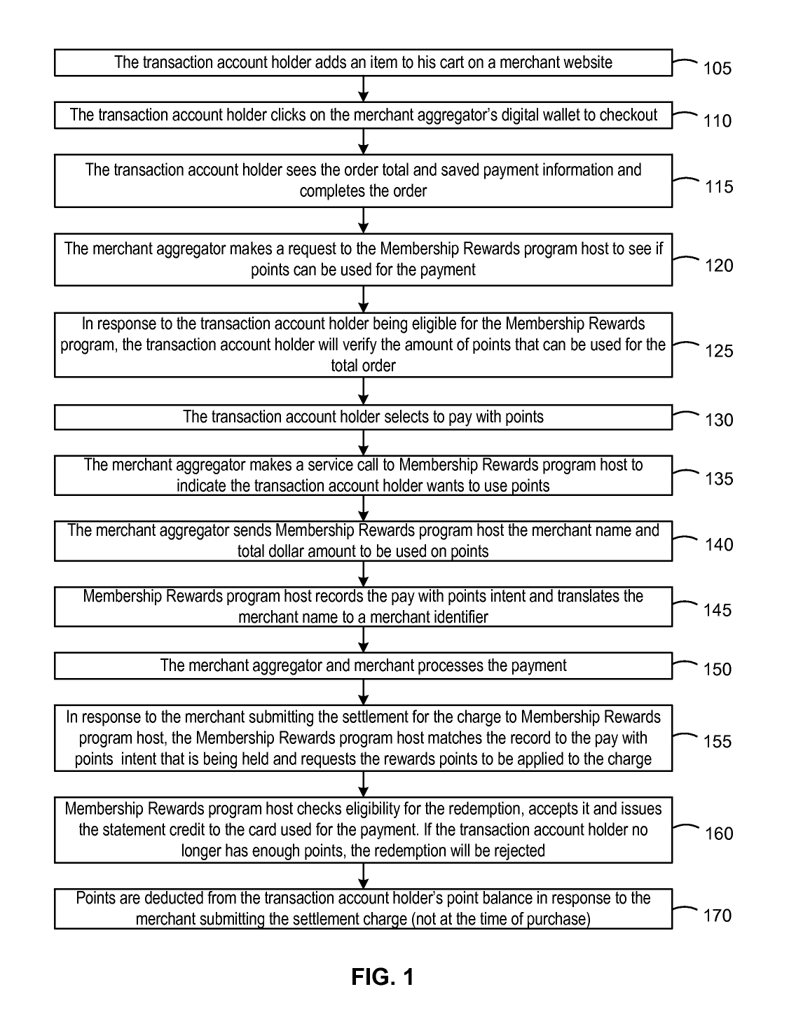

In various embodiments, and with reference to FIG. 1, a block diagram depicting a process flow of a transaction system 100 is illustrated. Initially, a transaction account holder may add an item to his virtual cart on a merchant website (Step 105). The transaction account holder may click on the merchant aggregator's digital wallet, such a Paypal® icon, to checkout; (Step 110). The transaction account holder sees the order total and saved payment information and completes the order (Step 115). The merchant aggregator makes a request to the membership rewards program host to see if points can be used for the payment (Step 120). The membership rewards program host may be the issuer of the transaction account utilized in the transition and/or the processor of the transaction. In response to the transaction being eligible for the membership rewards program, the transaction account holder will verify the amount of points that can be used for the total order (Step 125). The transaction account holder selects to pay with points (PWP) (Step 130). The merchant aggregator system may transmit a service call to a membership rewards program host system to indicate the transaction account holder wants to use points (Step 135). The service call may be transmitted through a merchant point of sale (POS) system, such as a physical POS device or a virtual POS system and/or an application program interface (API).

The merchant aggregator system may transmit to the membership rewards program host the merchant name (e.g., merchant identifier) and total dollar amount to be exchanged for points (Step 140). The membership rewards program host system records the PWP intent and translates the merchant name into a merchant identifier (Step 145). The merchant aggregator and merchant process the payment similar to a traditional transaction (Step 150). In response to the merchant submitting the settlement for the charge to membership rewards program host system, the membership rewards program host system matches and/or links the record to the PWP intent that is being stored and requests that rewards points to be applied to the charge (Step 155). The membership rewards program host system checks eligibility for the redemption, accepts it and issues the statement credit to the transaction account used for the payment. If the transaction account holder no longer has enough points, the redemption will be rejected (Step 160). Points are deducted from the transaction account holder's point balance in response to the merchant submitting the settlement charge (in contrast to be deducted at the time of purchase) (Step 170). As there can be a multi-day lag between the date when the purchase is consummated and when the merchant submits the charge, the price of the purchase can change, either up or down. System 100 may elect to use the best rate at the time of redemption (either the current rate or the rate at purchase time). The best rate may be a rate that favors the transaction account holder.

With continued reference, to FIG. 1, the transaction account holder may be registered for the merchant aggregator's digital wallet. This registration may occur at any time, including at the time of the transaction. According to various embodiments, the merchant aggregator and the merchant may be distinct entities. An eligible transaction account may be saved to the merchant aggregator's digital wallet. The transaction account holder data utilized to complete the order is saved (such as shipping address, billing address, transaction account code, transaction instrument expiration date). The transaction account holder may use points for the full purchase or perform a split tender transaction. The flow chart depicted in FIG. 1 assumes the transaction account holder has enough points to complete the purchase transaction. If the transaction account holder does not have enough points to complete the transaction at the time of PWP settlement, a default pre-selected transaction account may be utilized to complete the transaction. A notification may be transmitted to the transaction account holder to indicate a lack of points available to complete the transaction and/or the use of the default transaction account. Since an intended redemption does not actually reduce the point balance, a second redemption could be requested using the points that would have been used for the intended redemption. The membership rewards program host system will not prevent transaction account holders from over-committing for their intended redemptions. Instead, when the charges are submitted they will be redeemed against the available points, such as in the order the intended redemptions are received and/or in a manner that maximizes available point redemptions/reduces default transaction account charges. As noted above, if there are inadequate points for the intended redemption, such an intended redemption may be rejected.

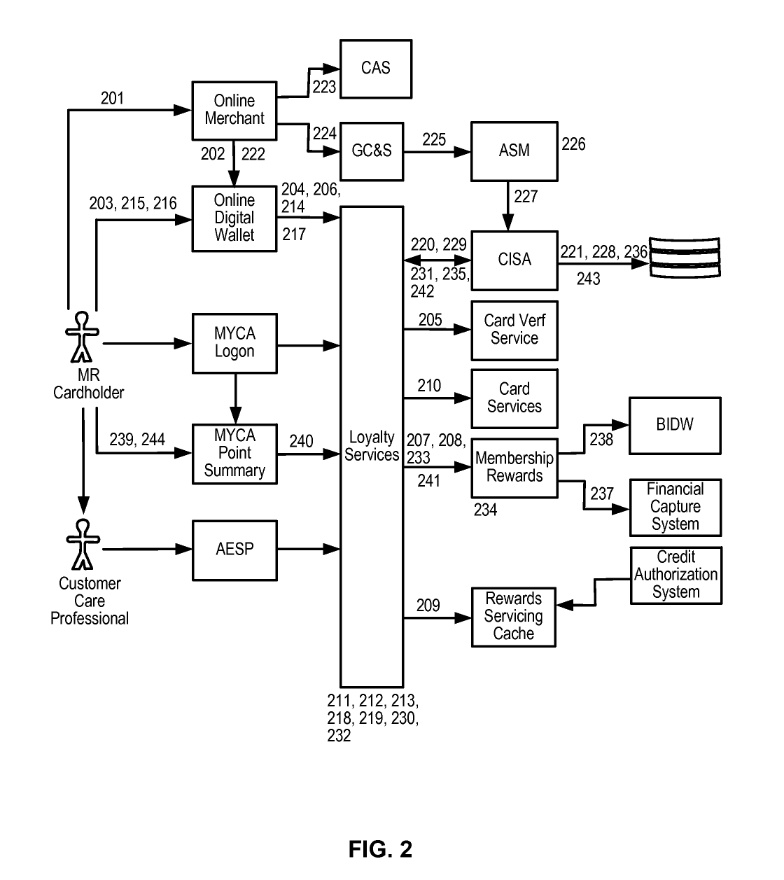

In various embodiments, and with reference to FIG. 2, a block diagram depicting portions of a process flow of system 100 is illustrated. A transaction account holder may visit an online merchant, shop, select merchandise (goods and/or services) and proceed to checkout (Step 201). The transaction account holder may use the merchant aggregator's digital wallet which launches a digital wallet layer (the user experience may be branded for the merchant) (Step 203). The transaction account holder may log into the online digital wallet (Step 204).

In response to the online digital wallet holding a participating transaction account, the merchant aggregator may make a request to establish a single-use session (passes transaction account issuer data and details) to a loyalty services provider. The loyalty services provider may validate the participating transaction account details with a card verification service module and establish single-use session (Step 205). The merchant aggregator may make a request to the membership rewards program host system to determine eligibility and point availability (Step 206). The membership rewards program host system verifies that the transaction account is enrolled in the membership rewards program (Step 207).

The membership rewards program host system verifies that the transaction account is available for participating in system 100 (Step 208). For instance, according to various embodiments corporate tier transaction accounts may not be eligible to participate in system 100. If a determination is made that a corporate tier transaction accounts is being utilized the PWP request may not be allowed to proceed.

The membership rewards program host system may verify the membership rewards account is eligible to be redeemed from a rewards servicing cache (RSeC) (Step 209). For instance, a check may be made that the transaction account is not past due and/or the like. The membership rewards program host system may verify the transaction account holder data to determine if the transaction account holder is a supplemental user (Step 210). According to various embodiments supplemental transaction account holders may not be granted authority in the account to spend loyalty points.

The membership rewards program host may review the merchant and/or merchant industry for each charge to determine if the merchant and/or merchant industry is populated to an exclude list. In response to the merchant and/or merchant industry being on the exclude list, the transaction may be declined as appropriate from participating in system 100 (Step 211).

The membership rewards program host may verify the merchant for each charge to see if the merchant is presenting a foreign charge. In response to the merchant presenting a foreign charge, the transaction may be declined as appropriate for system 100 (Step 212).

If eligible, the membership rewards program host system may convert a membership rewards account point balance into a currency equivalent, such as a US dollar equivalent (Step 213). The membership rewards program host system service may transmit, through an interface to a user, a point balance and/or the currency equivalent (Step 214).

According to various embodiments, in response to failing a verification, a decline message may be transmitted to the digital wallet and/or the merchant POS device. The digital wallet and/or the merchant POS device may communicate to the transaction account holder a message, via a display, that this transaction is not available to utilize PWP. The digital wallet and/or the merchant may determine the content of the message provided as desired. The message may communicate an indication of the problem, such as the merchant industry being on an exclude list and/or the indication of a foreign charge. The membership rewards program host system may store a record of the transmitted communication and the reason for the rejection of the PWP option.

The merchant aggregator may communicate with the transaction account holder if and how many points are available for payment (Step 215). Based on the merchant, the value of the points available may be adjusted. For instance a particular toy store chain may enter a contractual relationship with the membership rewards program host system such that a different conversion rate of points to currency is available as compared with a chain of hardware stores. Similarly, based on the digital wallet provider, the value of the points available in currency may be adjusted. In this way, a first digital wallet provider may enter a contractual relationship with the membership rewards program host system such that a different rate of points to currency is available for its member merchants as compared with the conversion rate available to a second digital wallet provider's merchants. The transaction account holder may elect to use points to pay the merchant charge (Step 216). The merchant aggregator may indicate that the transaction account holder desired to PWP and that points are to be used for a statement credit in response to a merchant charge being submitted. The merchant aggregator may request the transaction account issuer and/or the transaction account processor “Complete the Order” (Step 217).

The membership rewards program host system may verify the membership rewards account is eligible to PWP for the upcoming merchant charge. (Step 218). This process may be similar to the process described in step 207 through step 210).

The membership rewards program host system may translate merchant data communicated to the membership rewards program host into a known merchant identifier. (Step 219). The merchant aggregator may not have access to the merchant identifier used for authorizing/submitting charges, so the reference used by the merchant aggregator is provided to the membership rewards program host system. The membership rewards program host system may translate the merchant aggregator reference of the merchant to a known merchant identifier used by the transaction account processor, such as through referencing a database and/or use of a look-up table.

The membership rewards program host system may store and/or request a database store an intention registered by the transaction account holder to PWP for the transaction (Step 220, 221). As the merchant aggregator doesn't grant the authorization traditionally, the merchant grants the authorization, no transaction ID is available to be appended to the request to store an intention to PWP. Instead the transaction account code, merchant number, and charge amount is stored for later settlement.

The merchant aggregator may transmit information detailing the transaction account to be used for payment to the merchant site (Step 222). The merchant may request authorization of the transaction account for payment with a transaction account authorization system (CAS) (Step 223). The merchant may submit a settlement charge to a global clearing and settlement (GC&S) system for payment (Step 224). GC&S may provide a settlement charge to an authorization settlement matching (ASM) system (Step 225). The ASM may match and/or link the merchant charge and/or merchant transaction request with the intention registered by the transaction account holder to PWP for the transaction (Step 226, 227). A match may be located (Step 228). This match and/or link may be based on a variety of factors. These factors may include the transaction account holder identifier, transaction account, merchant, transaction value (and/or transaction value range). Stated another way, a system may be constantly comparing merchant charge and/or merchant transaction request with the pre-stored registered intentions to use PWP.

The membership rewards program host system may verify the intended pending charge as eligible from the membership rewards program host system (Step 229). The membership rewards program host system may perform steps 208 through steps 214 to determine eligibility and pricing (Step 230, 231, 232). The membership rewards program host system may request redemption with a membership rewards module (Step 233).

The membership rewards module may deduct points for redemption from the transaction account holders account and record charge details of the transaction and settlement (Step 234). The membership rewards program host system may confirm redemption to the system (Step 235). The database storing an intention registered by the transaction account holder to PWP for the transaction may be updated to reflect the completed transaction (Step 236).

The membership rewards module may issue a statement credit for the selected charge at any time, such as during its nightly batch process (Step 237). The membership rewards module may transmit redemption activity to a reporting module for reporting (Step 238). The transaction account holder may request the membership rewards program host system populate a list of intended pending charges/intended reward point redemption requests for selected transaction account from a membership reward interface. (Step 239-243). The transaction account holder may be logged into the membership reward interface. The list of intended pending redemptions of reward points may be displayed to a transaction account holder (Step 244). Merchants utilizing system 100 do not make changes to their systems to participate. In fact, merchants participating in system 100 may not know the transaction is a PWP transaction. Though system 100 is described as a system for integrating a PWP system with a third part digital wallet, it should be appreciated that the system may be applicable for integration with individual merchants and/or a chain of merchants.

In various embodiments, system 100 may include a processor configured to exchange loyalty points, a tangible, non-transitory storage memory configured to communicate with the processor, the tangible, non-transitory memory having instructions stored thereon that, in response to execution by the processor, cause the processor to exchange loyalty points as described below.

In various embodiments, the membership rewards module and/or the membership rewards program host system may maintain a middleware system 200 for converting and/or exchanging loyalty points to a currency equivalent. Further, the transactions described here may occur over any computerized network via any suitable user interface system (e.g., internet, phone, wireless, POS terminal, etc.). As used herein, the term “computerized network” includes, but is not limited to any network implemented in the form of a wire-based network (including telephone and cable lines), or as a wireless network (including satellite or cellular networks). It should be noted that the conversion ratio may vary from merchant to merchant according to the merchant's affiliation, if any, with the membership rewards program host system. Through the loyalty system middleware conversion application 200, the membership rewards program host system may adjust conversion ratios to take into account various promotional or incentive marketing programs in order to better serve the needs of its participants or affiliated merchants. By further example, if the membership rewards program host system desired to run a promotional program with a valued merchant, the conversion ratio for exchanging loyalty points to currency at an indicated merchant may be twice the amount for that of an ordinary merchant. In various exemplary embodiments, the membership rewards program host system may guarantee the transaction by providing a cash, cash equivalent, and/or loyalty point redemption to the merchant provider of items in the event of a default and/or problem with the transaction settlement.

Unlike traditional purchases using the redemption of loyalty points, the loyalty point exchange details (e.g., temporary or semi-permanent account identifier, etc.) are not provided to the individual merchants whom complete the transaction. The merchant requests processing of the transaction and settlement as is generally done with routine transaction account purchases.

During the account reconciliation phase, the accounts receivable system reconciles the charge for the particular transaction with a debit to the transaction account holder's loyalty/rewards points account. In various embodiments, for each transaction where the participant selected to pay with loyalty points, there will be a corresponding and offsetting reduction of loyalty points. In various embodiments, where the transaction account holder desires to pay only part of the transaction amount with loyalty points, the loyalty credit will only partially offset the merchant charge and the remainder will be paid with the transaction account holder's transaction instrument.

Stated another way, in various embodiments an online merchant will continue to first issue a charge corresponding to the electronic transaction authorized by the transaction account holder and a second request will be made by the merchant, its aggregator or other payment service provider, as applicable, to identify that rewards points are to be used to pay for a charge in response to the charge being submitted by the merchant. This approach ensures a merchant charge is in place before a reward point settlement occurs. The difference, however, with conventional approaches is that the merchant or its service provider is the party identifying (registering) the intent to use points rather than the a transaction issuer and/or loyalty point system proprietary app.

As depicted in FIG. 2, system 100 may comprise various subsystems and applications, some of which are part of the loyalty program systems, some of which are part of the membership rewards program host system banking system 100 and database structure, and some of which are used to facilitate interaction between the various systems.

The transaction account holder, as used throughout this application, should be understood to mean any individual, business or other entity that desires to use any non-currency tender such as loyalty points to facilitate a transaction. The transaction account holder may also be known as and occasionally referred to herein as a “customer,” “cardholder,” “user,” “card member,” or the like. In various embodiments, although the transaction account holder may be an existing transaction account holder, this is not required. The transaction account holder shall mean any person, entity, government organization, business, machine associated with a transaction account, regardless of whether a physical card is associated with the account. For example, the transaction account holder may include a transaction account owner, a transaction account user, an account affiliate, a child account user, a subsidiary account user, a beneficiary of an account, a custodian of an account, or any other person or entity affiliated or associated with a transaction account. Although the transaction account holder will generally be enrolled in a loyalty program, such as the American Express membership rewards® Program, and will have accumulated loyalty points, this is also not required.

Although the non-currency tender referred to throughout this disclosure is frequently referred to as “loyalty points,” and/or “reward points” this disclosure is not so limited. It should be understood the loyalty points includes any type of non-currency tender or that may be exchanged for an item, such as coupons, frequent flyer miles, incentive awards, frequency awards, reward points and the like. One example of loyalty points contemplated by this disclosure is the membership reward points awarded to participants in the American Express membership rewards® program.

Phrases and terms similar to an “item” may include any good, service, information, experience, entertainment, data, discount, rebate, points, virtual currency, content, access, rental, lease, contribution, account, credit, debit, benefit, right, reward, points, coupons, credits, monetary equivalent, anything of value, something of minimal or no value, monetary value, non-monetary value and/or the like. Moreover, the “transactions” or “purchases” discussed herein may be associated with an item. Furthermore, a “reward” may be an item.

Communication among the transaction account holder, merchant, merchant aggregator, digital wallet system, the membership rewards program host system or additional third parties (as may be contemplated by various embodiments) may take place over any computerized network via any suitable user interface system that allow for the exchange of analog or digital information. As such, these systems may include, but are not limited to, telephone interactive voice response or operator-facilitated systems, online or offline computer networked systems using various transfer protocols, wireless devices, personal data assistants, interactive TV, broadband, ultrawide band devices, transponders and the like. For example, the user interface system may comprise web servers and applications configured to facilitate client/server communication over the internet via any wireless or wire-based system. It is also contemplated that certain physical offers, such as coupons, accumulation offers (e.g., buy 9 get one free) may be accommodated by the system 100. In various embodiments, offers may comprise a scanable SKU, barcode, or other code which can be inputted by a user either by taking a photograph or through data entry and submitted to the membership rewards module for processing.

The membership rewards module and/or loyalty programs described herein may be any computer system for managing, tracking, and/or reporting loyalty program information. As previously described, the traditional loyalty systems allow transaction account holders to accumulate points in a loyalty program account and to then redeem points for merchandise. For example, the American Express membership rewards® system allows participants to accumulate points by using their transaction card (American Express® card) to make purchases or by shopping with merchants. The loyalty program, as contemplated by system 100, may be a stand-alone system or may be affiliated or integrated with other loyalty programs or transaction networks. Moreover, as previously stated, use of system 100 may function to integrate third party digital wallet providers with relationships with a plurality of merchants.

The charge authorization system (CAS), the financial capture system (FINCAP), the accounts payable system (AP) and the accounts receivable system (AR) systems are systems employed by transaction account issuers and card transaction account acquirers to authorize merchant transaction requests and process settlement requests. For example, an exemplary CAS may receive an authorization request from a merchant to determine if the financial transaction account associated with a transaction account code is valid and has sufficient credit. CAS includes systems for comparing the transaction details (e.g., account code, monetary amount of transaction, expiration date, etc.) with the transaction account holder's financial transaction account information to determine if the financial transaction account is active and if a sufficient credit limit exists to complete a transaction. If these conditions are satisfied, CAS returns to the merchant an approval code reflecting that the merchant is authorized to complete the transaction. The loyalty system middleware 200 or loyalty program may also either reference this same CAS as shown in FIG. 2 to determine if the transaction account holder's loyalty account information is valid (and with sufficient loyalty points) or may invoke a separate CAS component and/or CAS equivalent (not shown) to complete the same task.

The merchant computer and/or digital wallet and the membership rewards program host system may be interconnected via a second network, referred to as a payment network. The payment network represents existing proprietary networks that presently accommodate transactions for credit cards, debit cards, and other types of financial/banking instruments. The payment network is a closed network that is assumed to be secure from eavesdroppers. Examples of the payment network include the American Express®, VisaNet® and the Veriphone® network. While various embodiments are described in association with a transaction system, the disclosure contemplates any type of networks or transaction systems, including, for example, unsecure networks, public networks, wireless networks, closed networks, open networks, intranets, extranets, and/or the like.

The transaction phase generally includes a transaction account holder's successful registration and enrollment to use the present system 100 and method. In general, although not required, a transaction account holder will have registered to participate in a loyalty program and will have accumulated at least some loyalty points.

Practitioners will appreciate that the systems and methods described herein, in addition to being used in the context of a merchant website, may similarly be used in the context of telephone purchases, mail order purchases, and any other purchasing scenario where face-to-face interaction is limited or nonexistent.

Any communication, transmission and/or channel discussed herein may include any system or method for delivering content (e.g. data, information, metadata, etc.), and/or the content itself The content may be presented in any form or medium, and in various embodiments, the content may be delivered electronically and/or capable of being presented electronically. For example, a channel may comprise a website, a uniform resource locator (“URL”), a document (e.g., a Microsoft® Word document, a Microsoft® Excel document, an Adobe .pdf document, etc.), an “ebook,” an “emagazine,” an application or microapplication (as described below), an SMS or other type of text message, an email, facebook®, twitter®, MMS and/or other type of communication technology. In various embodiments, a channel may be hosted or provided by a data partner. In various embodiments, the distribution channel and/or may comprise at least one of a merchant website, a social media website, affiliate or partner websites, an external vendor, a mobile device communication, social media network and/or location based service. Distribution channels may include at least one of a merchant website, a social media site, affiliate or partner websites, an external vendor, and a mobile device communication. Examples of social media sites include Facebook®, foursquare®, Twitter®, MySpace®, LinkedIn® , and the like. Examples of affiliate or partner websites include American Express®, Groupon®, LivingSocial®, and the like. Moreover, examples of mobile device communications include texting, email, and mobile applications for smartphones.

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

Phrases and terms similar to an “entity” may include any individual, consumer, customer, group, business, organization, government entity, transaction account issuer or processor (e.g., credit, charge, etc.), merchant, consortium of merchants, account holder, charitable organization, software, hardware, and/or any other type of entity. The terms “user,” “consumer,” “purchaser,” and/or the plural form of these terms are used interchangeably throughout herein to refer to those persons or entities that are alleged to be authorized to use a transaction account.

Phrases and terms similar to “account”, “account number”, “account code” or “consumer account” as used herein, may include any device, code (e.g., one or more of an authorization/access code, personal identification number (“PIN”), Internet code, other identification code, and/or the like), number, letter, symbol, digital certificate, smart chip, digital signal, analog signal, biometric or other identifier/indicia suitably configured to allow the consumer to access, interact with or communicate with the system. The account number may optionally be located on or associated with a rewards account, charge account, credit account, debit account, prepaid account, telephone card, embossed card, smart card, magnetic stripe card, bar code card, transponder, radio frequency card or an associated account.

The account number or account code may be distributed and stored in any form of plastic, electronic, magnetic, radio frequency, wireless, audio and/or optical device capable of transmitting or downloading data from itself to a second device. A consumer account number may be, for example, a sixteen-digit account number, although each credit provider has its own numbering system, such as the fifteen-digit numbering system used by American Express. Each company's account numbers comply with that company's standardized format such that the company using a fifteen-digit format will generally use three-spaced sets of numbers, as represented by the number “0000 000000 00000”. The first five to seven digits are reserved for processing purposes and identify the issuing bank, account type, etc. In this example, the last (fifteenth) digit is used as a sum check for the fifteen digit number. The intermediary eight-to-eleven digits are used to uniquely identify the consumer. A merchant account number may be, for example, any number or alpha-numeric characters that identify a particular merchant for purposes of account acceptance, account reconciliation, reporting, or the like.

In various embodiments, an account number and/or account code may identify a consumer. In addition, in various embodiments, a consumer may be identified by a variety of identifiers, including, for example, an email address, a telephone number, a cookie id, a radio frequency identifier (RFID), a biometric, and the like.

Phrases and terms similar to “transaction account” may include any account that may be used to facilitate a financial transaction.

Phrases and terms similar to “financial institution,” or “transaction account issuer” may include any entity that offers transaction account services. Although often referred to as a “financial institution,” the financial institution may represent any type of bank, lender or other type of account issuing institution, such as credit card companies, card sponsoring companies, or third party issuers under contract with financial institutions. It is further noted that other participants may be involved in some phases of the transaction, such as an intermediary settlement institution.

Phrases and terms similar to “business” or “merchant” may be used interchangeably with each other and shall mean any person, entity, distributor system, software and/or hardware that are a provider, broker and/or any other entity in the distribution chain of goods or services. For example, a merchant may be a grocery store, a retail store, a travel agency, a service provider, an on-line merchant or the like.

Phrases and terms similar to “merchant,” “supplier” or “seller” may include any entity that receives payment or other consideration. For example, a supplier may request payment for goods sold to a buyer who holds an account with a transaction account issuer.

Phrases similar to a “payment processor” may include a company (e.g., a third party) appointed (e.g., by a merchant) to handle transactions. A payment processor may include an issuer, acquirer, authorizer and/or any other system or entity involved in the transaction process. Payment processors may be broken down into two types: front-end and back-end. Front-end payment processors have connections to various transaction accounts and supply authorization and settlement services to the merchant banks' merchants. Back-end payment processors accept settlements from front-end payment processors and, via The Federal Reserve Bank, move money from an issuing bank to the merchant bank. In an operation that will usually take a few seconds, the payment processor will both check the details received by forwarding the details to the respective account's issuing bank or card association for verification, and may carry out a series of anti-fraud measures against the transaction. Additional parameters, including the account's country of issue and its previous payment history, may be used to gauge the probability of the transaction being approved. In response to the payment processor receiving confirmation that the transaction account details have been verified, the information may be relayed back to the merchant, who will then complete the payment transaction. In response to the verification being denied, the payment processor relays the information to the merchant, who may then decline the transaction.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., Windows NT, Windows 95/98/2000, Windows XP, Windows Vista, Windows 7, OS2, UNIX, Linux, Solaris, MacOS, etc.) as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations. Useful machines for performing the various embodiments include general purpose digital computers or similar devices.

In fact, in various embodiments, the embodiments are directed toward one or more computer systems capable of carrying out the functionality described herein. The computer system includes one or more processors, such as processor. The processor is connected to a communication infrastructure (e.g., a communications bus, cross over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

Computer system also includes a main memory, such as for example random access memory (RAM), and may also include a secondary memory. The secondary memory may include, for example, a hard disk drive and/or a removable storage drive, representing a floppy disk drive, a magnetic tape drive, an optical disk drive, etc. The removable storage drive reads from and/or writes to a removable storage unit in a well-known manner. Removable storage unit represents a floppy disk, magnetic tape, optical disk, etc. which is read by and written to by removable storage drive. As will be appreciated, the removable storage unit includes a computer usable storage medium having stored therein computer software and/or data.

In various embodiments, secondary memory may include other similar devices for allowing computer programs or other instructions to be loaded into computer system. Such devices may include, for example, a removable storage unit and an interface. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from the removable storage unit to computer system.

Computer system may also include a communications interface. Communications interface allows software and data to be transferred between computer system and external devices. Examples of communications interface may include a modem, a network interface (such as an Ethernet card), a communications port, a Personal Computer Memory Card International Association (PCMCIA) slot and card, etc. Software and data transferred via communications interface are in the form of signals which may be electronic, electromagnetic, optical or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

The terms “computer program medium” and “computer usable medium” are used to generally refer to media such as removable storage drive and a hard disk installed in hard disk drive. These computer program products provide software to computer system.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program product and loaded into computer system using removable storage drive, hard disk drive or communications interface. The control logic (software), when executed by the processor, causes the processor to perform the functions of various embodiments as described herein. In various embodiments, hardware components such as application specific integrated circuits (ASICs). Implementation of the hardware state machine so as to perform the functions described herein will be apparent to persons skilled in the relevant art(s).

A web client includes any device (e.g., personal computer) which communicates via any network, for example such as those discussed herein. Such browser applications comprise Internet browsing software installed within a computing unit or a system to conduct online transactions and/or communications. These computing units or systems may take the form of a computer or set of computers, although other types of computing units or systems may be used, including laptops, notebooks, tablets, hand held computers, personal digital assistants, set-top boxes, workstations, computer-servers, main frame computers, mini-computers, PC servers, pervasive computers, network sets of computers, personal computers, such as iPads®, iMACs®, and MacBooks®, kiosks, terminals, point of sale (POS) devices and/or terminals, televisions, or any other device capable of receiving data over a network. A web-client may run Microsoft Internet Explorer®, Mozilla Firefox®, Google Chrome®, Apple Safari®, or any other of the myriad software packages available for browsing the internet.

Practitioners will appreciate that a web client may or may not be in direct contact with an application server. For example, a web client may access the services of an application server through another server and/or hardware component, which may have a direct or indirect connection to an Internet server. For example, a web client may communicate with an application server via a load balancer. In various embodiments, access is through a network or the Internet through a commercially-available web-browser software package.

As those skilled in the art will appreciate, a web client includes an operating system (e.g., Windows NT, 95/98/2000/CE/Mobile, OS2, UNIX, Linux, Solaris, MacOS, PalmOS, etc.) as well as various conventional support software and drivers typically associated with computers. A web client may include any suitable personal computer, network computer, workstation, personal digital assistant, cellular phone, smart phone, minicomputer, mainframe or the like. A web client can be in a home or business environment with access to a network. In various embodiments, access is through a network or the Internet through a commercially available web-browser software package. A web client may implement security protocols such as Secure Sockets Layer (SSL) and Transport Layer Security (TLS). A web client may implement several application layer protocols including http, https, ftp, and sftp.

In various embodiments, components, modules, and/or engines of the system may be implemented as micro-applications or micro-apps. Micro-apps are typically deployed in the context of a mobile operating system, including for example, a Palm mobile operating system, a Windows mobile operating system, an Android Operating System, Apple iOS, a Blackberry operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing at http://csrc.nist.gov/groups/SNS/cloud-computing/cloud-def-v15.doc (last visited Feb. 4, 2011), which is hereby incorporated by reference in its entirety.

As used herein, “transmit” may include sending electronic data from one system component to another over a network connection. Additionally, as used herein, “data” may include encompassing information such as commands, queries, files, data for storage, and the like in digital or any other form.

The system contemplates uses in association with web services, utility computing, pervasive and individualized computing, security and identity solutions, autonomic computing, cloud computing, commodity computing, mobility and wireless solutions, open source, biometrics, grid computing and/or mesh computing.

Any databases discussed herein may include relational, hierarchical, graphical, or object-oriented structure and/or any other database configurations. Encryption may be performed by way of any of the techniques now available in the art or which may become available—e.g., Twofish, RSA, El Gamal, Schorr signature, DSA, PGP, PKI, GPG (GnuPG), and symmetric and asymmetric cryptosystems. The computers discussed herein may provide a suitable website or other Internet-based graphical user interface which is accessible by users.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), AJAX (Asynchronous Javascript And XML), helper applications, plug-ins, and the like. A server may include a web service that receives a request from a web server, the request including a URL (http://yahoo.com/stockquotes/ge) and an IP address (123.56.789.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the Internet server. Middleware may be configured to process transactions between the various components of an application server and any number of internal or external systems for any of the purposes disclosed herein. WebSphere MQ™ (formerly MQSeries) by IBM, Inc. (Armonk, N.Y.) is an example of a commercially available middleware product. An Enterprise Service Bus (“ESB”) application is another example of middleware.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, VBScript, Macromedia Cold Fusion, COBOL, Microsoft Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

As used herein, the term “end user”, “consumer”, “customer”, “card member”, “business” or “merchant” may be used interchangeably with each other, and each shall mean any person, entity, government organization, business, machine, hardware, and/or software. A bank may be part of the system, but the bank may represent other types of card issuing institutions, such as credit card companies, card sponsoring companies, or third party issuers under contract with financial institutions. It is further noted that other participants may be involved in some phases of the transaction, such as an intermediary settlement institution, but these participants are not shown.

Each participant is equipped with a computing device in order to interact with the system and facilitate online commerce transactions. The customer has a computing unit in the form of a personal computer, although other types of computing units may be used including laptops, notebooks, hand held computers, set-top boxes, cellular telephones, touch-tone telephones and the like. The merchant has a computing unit implemented in the form of a computer-server, although other implementations are contemplated by the system. The bank has a computing center shown as a main frame computer. However, the bank computing center may be implemented in other forms, such as a mini-computer, a PC server, a network of computers located in the same of different geographic locations, or the like. Moreover, the system contemplates the use, sale or distribution of any goods, services or information over any network having similar functionality described herein

The merchant computer and the bank computer may be interconnected via a second network, referred to as a payment network. The payment network which may be part of certain transactions represents existing proprietary networks that presently accommodate transactions for credit cards, debit cards, and other types of financial/banking cards. The payment network is a closed network that is assumed to be secure from eavesdroppers. Exemplary transaction networks may include the American Express®, VisaNet® and the Veriphone® networks.

The electronic commerce system may be implemented at the customer and issuing bank. In an exemplary implementation, the electronic commerce system is implemented as computer software modules loaded onto the customer computer and the banking computing center. The merchant computer does not require any additional software to participate in the online commerce transactions supported by the online commerce system.

As will be appreciated by one of ordinary skill in the art, the system may be embodied as a customization of an existing system, an add-on product, a processing apparatus executing upgraded software, a stand-alone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, webpages, websites, web forms, prompts, etc. Practitioners will appreciate that the illustrated steps described herein may comprise in any number of configurations including the use of windows, webpages, web forms, popup windows, prompts and the like. It should be further appreciated that the multiple steps as illustrated and described may be combined into single webpages and/or windows but have been expanded for the sake of simplicity. In other cases, steps illustrated and described as single process steps may be separated into multiple webpages and/or windows but have been combined for simplicity.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. §101.

Systems, methods and computer program products are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. After reading the description, it will be apparent to one skilled in the relevant art(s) how to implement the disclosure in alternative embodiments.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112 (f), unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A computer-implemented method comprising:
receiving, by a computer based system configured for reward point spend, an inquiry from a merchant aggregator system to a membership rewards program host system to verify that rewards points can be used for a payment of a transaction;
verifying, by the computer based system and in response to the transaction being eligible for a membership rewards program, an amount of rewards points that can be used to complete the transaction;
receiving, by the computer based system, a selection to pay with points from the membership rewards program, wherein the merchant aggregator system transmits a service call to the membership rewards program host system to indicate a transaction account holder intends to pay with points for the transaction;
recording, by the computer based system, the pay with points intent, wherein the transaction is processed utilizing a transaction account by a payment processor to form a processed transaction;
linking, by the computer based system, a record of the processed transaction with the recorded pay with points intent in response to a merchant submitting a settlement request for the transaction;
requesting, by the computer based system, that a credit be applied to the transaction account in an amount of the transaction and that an associated amount of rewards points be reduced in a transaction account holder's membership rewards program rewards points account in response to forming the link;
issuing, by the computer based system, a statement credit to the transaction account used for the payment of the transaction; and
reducing, by the computer based system, the associated amount of rewards points in the transaction account holder's membership rewards program rewards points account based on the request passing conditions.

2. The computer-implemented method of claim 1, wherein an order total and saved payment information is presented via an interface to the transaction account holder.

3. The computer-implemented method of claim 1, wherein the membership rewards program host system is at least one of an issuer of the transaction account utilized in the transaction or a processor of the transaction.

4. The computer-implemented method of claim 1, wherein the service call is transmitted through at least one of a Merchant point of sale system or an application program interface.

5. The computer-implemented method of claim 1, further comprising selecting, by the computer based system, a merchant aggregator's digital wallet system for completing the transaction.

6. The computer-implemented method of claim 1, further comprising converting, by the computer based system, rewards points to currency.

7. The computer-implemented method of claim 6, wherein a conversion rate of rewards points to currency is specific to each merchant integrated with the merchant aggregator system.

8. The computer-implemented method of claim 1, wherein the selection to pay with points from the membership rewards program is selected by the transaction account holder transmitted from at least one of the merchant aggregator system or a merchant system.

9. The computer-implemented method of claim 1, wherein the merchant aggregator system is a third party system.

10. The computer-implemented method of claim 1, further comprising receiving, by the computer based system, by the membership rewards program host system from the merchant aggregator system a merchant name and a total dollar amount to be exchanged for rewards points.

11. The computer-implemented method of claim 1, wherein the membership rewards program host system translates merchant data received from the merchant aggregator system name into a known merchant identifier traditionally utilized by the membership rewards program host system.

12. The computer-implemented method of claim 1, further comprising verifying, by the computer based system, eligibility for the pay with points redemption.

13. The computer-implemented method of claim 1, wherein the merchant submits the settlement request for the transaction to a transaction account issuer system.

14. The computer-implemented method of claim 1, wherein in response to the transaction account holder no longer having enough points to pay with points at the time of settlement, the pay with points redemption is rejected and a charge to the transaction account for the transaction is maintained.

15. The computer-implemented method of claim 1, wherein a merchant aggregator of the merchant aggregator system and the merchant are distinct entities.

16. The computer-implemented method of claim 1, wherein membership rewards program host system scans each received transaction submitted for settlement to attempt to form a link to a recorded pay with points intent.

17. The computer-implemented method of claim 1, wherein the linking is based on at least one of a transaction amount, a transaction holder identifier, or a merchant identifier.

18. The computer-implemented method of claim 1, wherein reward points are deducted from a transaction account holder's membership rewards program rewards points balance in response to the merchant submitting the settlement request, wherein the transaction account holder's membership rewards program rewards points balance is unaffected at the time of the transaction.

19. An article of manufacture including a non-transitory, tangible computer readable storage medium having instructions stored thereon that, in response to execution by a computer based system configured for reward point spend, cause the computer based system to be capable of performing operations comprising:
receiving, by the computer based system, an inquiry from a merchant aggregator system to a membership rewards program host system to verify that rewards points can be used for a payment of a transaction;
verifying, by the computer based system, in response to the transaction being eligible for a membership rewards program, an amount of rewards points that can be used to complete the transaction;
receiving, by the computer based system, a selection to pay with points from the membership rewards program, wherein the merchant aggregator system transmits a service call to the membership rewards program host system to indicate a transaction account holder intends to pay with points for the transaction;
recording, by the computer based system, the pay with points intent, wherein the transaction is processed utilizing a transaction account by a payment processor to form a processed transaction;
linking, by the computer based system, a record of the processed transaction with the recorded pay with points intent in response to a merchant submitting a settlement request for the transaction;
requesting, by the computer based system, that a credit be applied to the transaction account in an amount of the transaction and that an associated amount of rewards points be reduced in a transaction account holder's membership rewards program rewards points account in response to forming the link;
issuing, by the computer based system, a statement credit to the transaction account used for the payment of the transaction; and
reducing, by the computer based system, the associated amount of rewards points in the transaction account holder's membership rewards program rewards points account based on the request passing conditions.

20. A system comprising:
a processor configured for reward point spend,
a tangible, non-transitory memory configured to communicate with the processor, the tangible, non-transitory memory having instructions stored thereon that, in response to execution by the processor, causes the processor to be capable of performing operations comprising:
receiving, by the processor, an inquiry from a merchant aggregator system to a membership rewards program host system to verify that rewards points can be used for a payment of a transaction;
verifying, by the processor, in response to the transaction being eligible for a membership rewards program, an amount of rewards points that can be used to complete the transaction;
receiving, by the processor, a selection to pay with points from the membership rewards program, wherein the merchant aggregator system transmits a service call to the membership rewards program host system to indicate a transaction account holder intends to pay with points for the transaction;
recording, by the processor, the pay with points intent, wherein the transaction is processed utilizing a transaction account by a payment processor to form a processed transaction;
linking, by the processor, a record of the processed transaction with the recorded pay with points intent in response to a merchant submitting a settlement request for the transaction;
requesting, by the processor, that a credit be applied to the transaction account in an amount of the transaction and that an associated amount of rewards points be reduced in a transaction account holder's membership rewards program rewards points account in response to forming the link;
issuing, by the processor, a statement credit to the transaction account used for the payment of the transaction;
reducing, by the processor, the associated amount of rewards points in the transaction account holder's membership rewards program rewards points account based on the request passing conditions.
